(19) United States
(12) Patent Application Publication
(10) Pub. No.: US 2008/0227071 A1
(43) Pub. Date: Sep. 18, 2008

(54) Method and device to encourage children to brush their teeth

(76) Inventors: Maya Gavriel, Shoham (IL); Uzi Ezra Havosha, Tel Aviv (IL)

Correspondence Address: UZI EZRA HAVOSHA & PARTNERS, HADAR-DAFNA HOUSE 39 SHAOUL HAMELECH STREET, TEL AVIV, 64928, IL

(21) Appl. No.: 11/716,941

(22) Filed: Mar. 13, 2007

(51) Int. Cl. G09B 23/00

(52) U.S. Cl. 434/263

(57) ABSTRACT

A doll or other object used to remind and encourage children to brush their teeth. This could include adjustable time setting to operate at certain times of the day, physical movement of a brush over the doll's teeth, vocal reminders and encouragement to brush the teeth or movement sensor. Operation could be mechanical or electronic or a combination of the two.

### FIELD OF THE INVENTION

This invention is in the field of oral hygiene education and in particular a programmed facial figure imitating the teeth cleaning process together with vocal accompaniment and other features herein described.

### BACKGROUND OF THE INVENTION

It is well known in the art and in the medical profession that regular tooth brushing helps prevent tooth decay and also preserves the gums in a healthy state to enable them to hold the teeth firmly in position.

Children need constant reminding to brush their teeth, otherwise their teeth decay rapidly resulting in expensive dentistry work or in the case of further neglect, extraction of teeth.

Eventually regular brushing becomes a habit but until then, the parents have to remind their children every night and morning to brush their teeth.

This innovation comes to achieve the same result by means of physical, visual and vocal methods that will give positive reinforcement for children including automatic reminders at pre-set times.

### SUMMARY OF THE INVENTION

It is to be understood that both the foregoing general description and the following detailed description present embodiments of the invention, and are intended to provide an overview, or framework, for understanding the nature and character of the invention as it is claimed. The accompanying drawings are included to provide a further understanding of the invention, and are incorporated into and constitute a part of this specification. The drawings illustrate various embodiments of the invention and, together with the description serve to explain the principles and operations of the invention.

This invention uses, in one embodiment, simple mechanical and electronic means to achieve its goals not involving high-tec or digital technology. This factor will help reduce manufacturing costs and hence make the device marketable to a wider population.

A direct current battery operated electric motor could turn a threaded axle. With the aid of a timer the electric poles are switched at pre-set time intervals in order to reverse the direction of the said motor.

On the said thread is a nut that acts as a rider to carry the apparatus above it up and down the threaded axle. When the motor turns one way the nut and its attached apparatus will rise on the said thread and when it turns the opposite direction it will move down the said thread. The said apparatus is a doll or other figure that bares its teeth and brushes them with a hand held toothbrush at pre-set times and intervals. Inside the body of the said figure are the mechanical devices like the cog wheels, rods, pins, springs, that create the movements that emulate a person brushing their teeth and to which said mechanical devices the said doll or other figure is attached. The motions of the figure are caused by mechanical means involving innovative engineering powered by the same circular and vertical forces made when the said motor turns and the said nut moves up and down the said thread.

The said battery also could power a tape recording of words of reminder and/or encouragement and/or music to make the tooth brushing procedure into a more pleasant experience. This too could be operated at pre-set times to coincide with the times suitable for brushing teeth. The recording could be changed to add novelty and prevent boredom from the same message being repeated too often. A more sophisticated embodiment of this invention could include a sensor to detect the presence of someone in the bathroom between certain hours and only then operate the turning motor and tape recording. This detection could be for example, with an electronic eye, decibel sensitivity or attached to the light switch.

The tape recording could be of the digital variety.

In another embodiment of this invention there could be a more compact arrangement than described above requiring the use of somewhat higher technology, but nevertheless achieving the same goals. There could be an electronic chip in the doll or in the toothbrush held by the doll that would have the ability to operate one or more of the following an adjustable timer, a vocal recording, a movement sensor, flashing or non-flashing lights and to operate the mechanism to move the doll's hand (holding the toothbrush) back and forth to imitate tooth cleaning.

An object of this invention is to remind children to brush their teeth.

Another object of this invention is to so remind using relatively simple mechanical means.

Another object of another embodiment of this invention is to so remind using electronic chip and micro-processing technology.

Another object of this invention is to so remind at pre-set times.

Another object of this invention is to encourage children to brush their teeth using words of encouragement and positive reinforcement.

Another object of this invention is to show a visual example of a figure brushing its teeth.

Another object of this invention is for the said reminder, encouragement and visual effects to operate when it detects someone moving in a given radius from the said figure, between given times of the day.

Another object of this invention is for the said reminder, encouragement and visual effects to operate when it detects a certain adjustable level of noise, between given times of the day.

Another object of this invention is for the said reminder, encouragement and visual effects to operate when the light of the room is switched on, between given times of the day.

### BRIEF DESCRIPTION OF THE DRAWINGS

The accompanying drawings, which are incorporated in and form a part of this specification, illustrate embodiments of the invention and, together with the description, serve to explain, by way of example only, the principles of the invention:

Fig A is a schematic depiction of a figure of this invention.

Fig B is a schematic depiction of the mechanical apparatus inside the said figure as seen from the section view.

Fig C is a schematic depiction of the said apparatus in three dimensions from a 45° elevation.

Fig D is a schematic depiction of a doll holding a toothbrush that contains various electronic components.

### DESCRIPTION of the PREFERRED EMBODIMENTS

As will be appreciated the present invention is capable of other and different embodiments than those discussed above and described in more detail below, and its several details are capable of modifications in various aspects, all without departing from the spirit of the invention.

Accordingly, the drawings and description of the embodiments set forth below are to be regarded as illustrative in nature and not restrictive.

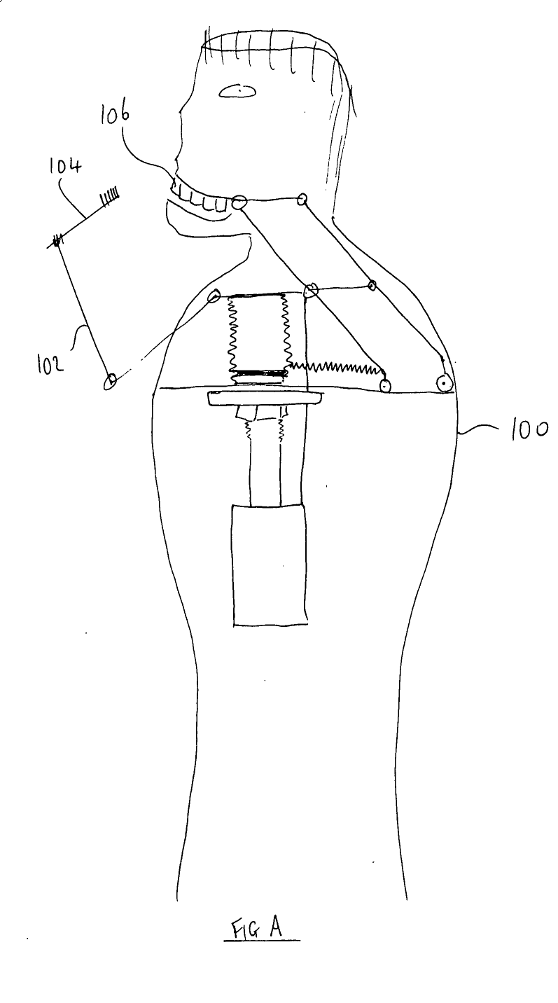

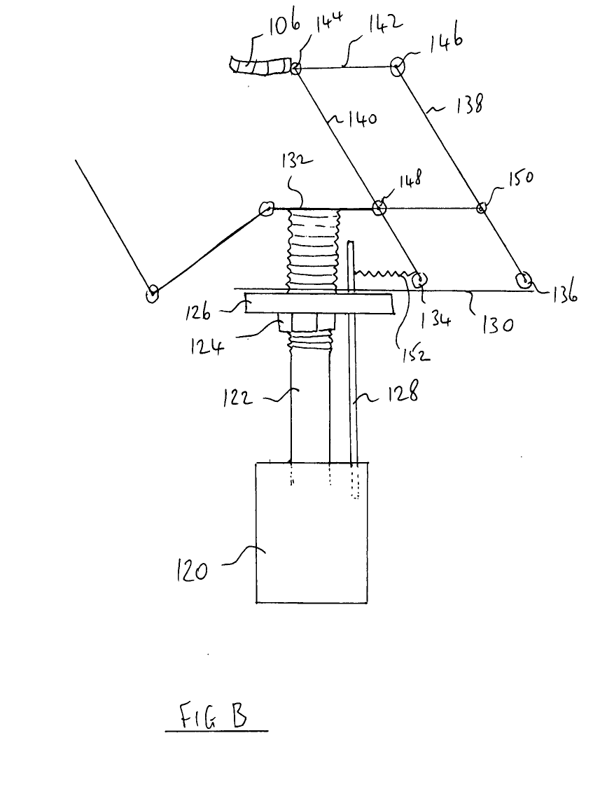

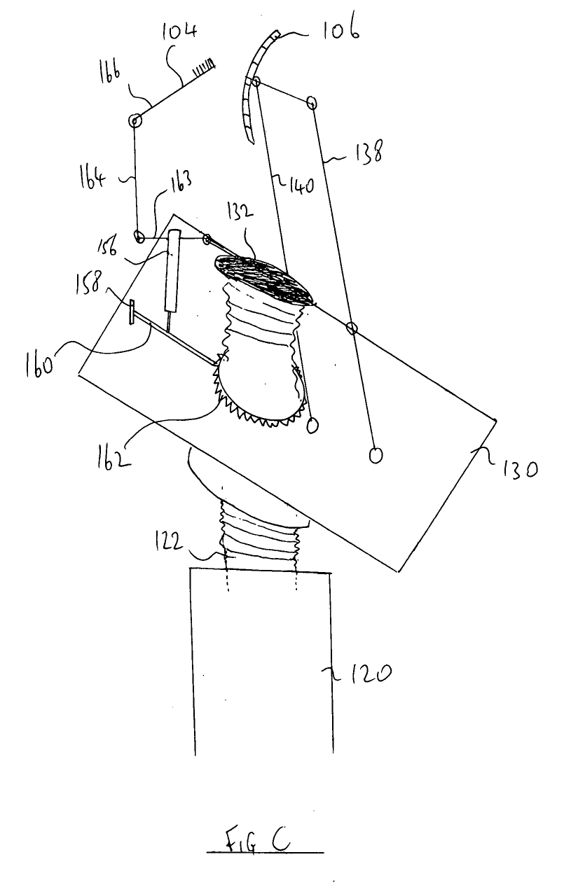

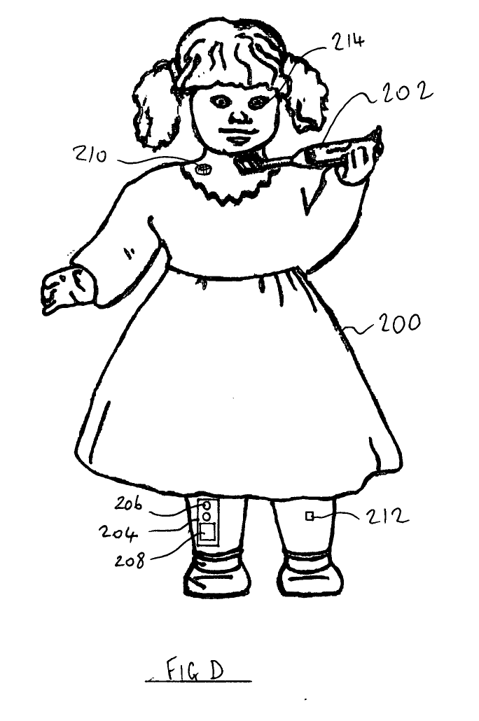

Fig A shows the doll or other FIG. 100 of this invention. The FIG. 100 could be self standing on a surface or attachable to a wall. The FIG. 100 would have an arm 102 with a hand holding a toothbrush 104. The arm 102 is so built that when it moves back and forth, the toothbrush 104 moves back and forth on the figure's teeth 106. The various mechanical parts like for example rods, levers, pivots springs and threaded bolts, seen in Fig A would be covered by the said doll's body and clothes and not readily visible.

Fig B shows the section view of mechanical apparatus inside the figure seen in Fig A 100. The housing 120 could contain a battery or other power source, a motor, a timing device attached to the battery terminals and a means to reverse the polarity of the electricity that operates the electric motor at settable time intervals.

The motor in housing 120 is attached to a threaded bolt 122 that turns about its longitudinal axis as the said motor turns and in the same direction as the turn of the said motor. When the said motor turns in a clockwise direction the nut 124 and everything attached to it, moves upwards towards the top of threaded bolt 122. When the direction of the motor is reversed, the nut 124 and its accompaniments 5 move downward accordingly.

A nut 124 with the fitting thread suitable to fit the thread of bolt 122 is screwed onto the bolt 122 and is attached to plate 126. Plate 126 has a hole at its center, large enough to slide over the thread of bolt 122. Rod 128 is attached to the motor housing 120 and passes through a hole in plate 126. The rod 128 keeps the plate 126 steady as it rides up and down the thread of bolt 122.

Surface 130 rests on top of plate 126. It too has a hole in it that allows the threaded bolt 122 to pass through it without 15 hindrance. On top of threaded bolt 122 is a small plate 132 that has a bearing in it to enable the bolt 122 to turn freely while leaving the plate 132 static.

The teeth 106 are attached to the rod 142 which in turn hold rods 138 and 140 parallel with the aid of the pivotal 20 moving joints 144, 146, 148 and 150. At the lower ends of rods 138 and 140 are wheels 134 and 136. As described above the plate 126 will move up and down the thread of bolt 122 being powered by the said motor. Rods 138 and 140 are attached to static plate 132 by means of the pivotal 25 moving joints 148 and 150.

The resultant effect of plate 126 rising up the thread of bolt 122 is that the teeth 106 will move forward, that is, to a position outside the mouth of the figure Fig A 100. Conversely, when plate 126 moves downwards the teeth 106 will move backward, that is, to a position inside the said mouth. This horizontal movement of the teeth is caused by the rods 138 and 140 being pivoted at the joints 148 and 150. When plate 126 rises, the wheels 134 and 136 will roll towards the right thereby causing the top end of rods 138 and 140, where teeth 106 are attached, to move to the left, giving the impression that the teeth are being exposed for the purpose of being brushed.

When the said motor reverses direction the plate 126 will move vertically downward. Spring 152 was under tension when the lower ends of rods 138 and 140 moved to the right. When plate 126 moves downwards, the spring's 152 potential energy is released and the spring 152 will pull the wheels 134 and 136 towards the left. Spring 152 is attached to the lower end of rod 140 and as rod 140 moves rod 138 moves with it in parallel. The resultant effect of the lower ends of rods 138 and 140 moving to the left is that the upper ends will move to the right thereby pulling the teeth 106 back inside the mouth of the figure in Fig A 100.

The second effect of the rising and falling of plate 126 is to cause the handheld toothbrush Fig A 104 to move sideways back and forth over the teeth 106. This is more clearly seen in Fig C and is therefore described in more detail in reference to Fig C.

Fig C shows the same mechanical apparatus inside the figure as shown in Fig B except the view is three dimensional and from a different angle. The housing 120 is at the base and the threaded bolt 122 is attached to the motor. The plate 126 holds the surface 130 and the apparatus thereon. The rods 138 and 140 and the said figure's teeth 106 are attached to one side of plate 132 and whose workings were described in Fig B. On the other side of plate 132 is the hand direction guider 156, the solid spring holder 158 and the solid spring 160. The hand direction guider 156 is attached to solid spring 160. The threaded cog wheel 162 rides on the thread of bolt 122, moving up and down as the bolt turns to the left and then to the right. When the cogwheel 162 turns, the solid spring 160 is pulled to the side by each tooth of cogwheel 162 and then springs back to its original position in between the said cogwheel teeth. Thus, as the cogwheel 162 turns, the resultant effect will be that the hand direction guider 156 will constantly move back and forth in a rapid oscillating motion. The upper end of the hand direction guider 156 has a vertical slit into which sits the first arm rod 163. This arm rod 163 is connected to the next arm rod 164 which is in turn connected to the arm 166 that holds the toothbrush 104. The relatively small oscillating movement of the hand direction guider 156 is magnified by the length of the arms 163, 164 and 166, to a larger back and forth movement of the toothbrush 104.

In summary, the resultant actions from the turning of threaded bolt 122 in one direction and later in the opposite direction, is firstly to make the teeth 106 come out of the figure's mouth for a period of time to be brushed and then withdrawn for a period of time into its mouth. Secondly, the hand-held brush 104 is in a constant back and forth brushing motion.

Fig D shows a doll 200 holding a toothbrush 202. The doll 200 has in it various electrical components for the operation 10 of the doll 200 by electronic as opposed to mainly mechanical means. There could be a control panel 204 on the leg of the doll 200 or on any other convenient part. There would be control buttons 206 to set the various components of the operation and a screen 208 to indicate to the user, information relevant to the said settings and operation. The doll 200 could be programmed to perform at least one of the following functions but not necessarily limited to these functions; to switch on and off at a pre-set times, to operate a recorded voice and/or music that could 20 be heard via the loudspeaker 210, to set in motion the toothbrush 202 to mimic the action of tooth brushing, to operate the device resulting from a detection of movement by an electronic eye 212, or resulting from a noise level detector or being connected to the light switch of the room 25 where the doll is situated and flashing lights 214.

The present invention is not intended to be limited to the embodiments described above, but to encompass any and all embodiments within the scope of the following claims:

1. A figure to mimic a person performing the action of tooth-brushing comprising,
a. an electric motor connected to an axle,
b. at least one of the following; connectors, pivots, rods, threaded rods, bolts, nuts, springs and cog wheels,
c. a source of electrical energy,
d. a tooth brush connected to a part capable of moving,
e. a means to regulate the time when the said motor operates,
whereby the figure will mimic a person brushing its teeth at pre-set times.

2. A figure as claimed in claim 1 wherein the figure is a doll.

3. A figure as claimed in claim 1 wherein the said pre-set times are adjustable.

4. A figure as claimed in claim 1 wherein the said connectors, pivots, rods, threaded rods, bolts, nuts, springs and cog wheels are connected in such a way that when the said motor operates the teeth of the said figure are exposed and the said toothbrush moves back and forth on the said teeth mimicking the tooth cleaning motions of a person.

5. A figure as claimed in claim 1 further comprising an electric eye that can detect the presence of an object in a given range and thereupon operate the electrical components of the said figure.

6. A figure as claimed in claim 1 further comprising a noise level detector that can operate the electrical components of the said figure when the pre-set noise is reached.

7. A figure as claimed in claim 1 further comprising an electrical connection between the said motor and the electrical circuit of a room lighting system.

8. A figure as claimed in claim 1 further comprising a means to replay recorded sounds and transmit them audibly via a loudspeaker.

9. A figure to mimic a person performing the action of tooth-brushing comprising,
a. a motor controlled by a micro-processor
b. operating switches connected to the said micro-processor to select and set the options of operation of the said figure which comprise of at least one of the following list namely, to move the tooth-brush over the mock teeth of the said figure, to so move at pre-set adjustable times, to operate sound recordings, to operate lights,
c. means to operate the said features in automatic ways,
whereby the figure will mimic a person brushing its teeth at pre-set times.

10. A figure as claimed in claim 9 wherein the figure is a doll.

11. A figure as claimed in claim 1 wherein the said pre-set times are adjustable.

12. A figure as claimed in claim 9 further comprising an electric eye that can detect the presence of an object in a given range and thereupon operate the electrical components of the said figure.

13. A figure as claimed in claim 9 further comprising a noise level detector that can operate the electrical components of the said figure when the pre-set noise is reached.

14. A figure as claimed in claim 9 further comprising an electrical connection between the said motor and the electrical circuit of a room lighting system.

15. A figure as claimed in claim 9 further comprising a means to replay recorded sounds and transmit them audibly via a loudspeaker.
